(19) United States
(12) Patent Application Publication
(10) Pub. No.: US 2013/0286095 A1
(43) Pub. Date: Oct. 31, 2013

(54) PRINT APPARATUS AND PRINT METHOD

(71) Applicant: SEIKO EPSON CORPORATION, Tokyo (JP)

(72) Inventors: Hiroshi WADA, Azumino (JP); Toru TAKAHASHI, Azumino (JP); Takamitsu KONDO, Shiojiri (JP); Kazuyoshi TANASE, Matsumoto (JP)

(73) Assignee: SEIKO EPSON CORPORATION, Tokyo (JP)

(21) Appl. No.: 13/871,102

(22) Filed: Apr. 26, 2013

(30) Foreign Application Priority Data
Apr. 27, 2012 (JP) 2012-103513

(51) Int. Cl. B41J 11/00

(52) U.S. Cl. CPC B41J 11/002
USPC 347/43

(57) ABSTRACT

A print device is provided with a conveyance unit for conveying a medium in a conveyance direction; a magenta head; a cyan head; a black head; a yellow head; a first light source; a clear head; and a second light source. The first light source is provided downstream in the conveyance direction than the color ink heads; the clear head is provided downstream than the first light source; the second light source is provided downstream than the clear head; and, where the irradiation energy needed for the main curing of the color inks is Pc, the irradiation energy needed for the main curing of the clear ink is Pcl, the irradiation energy of the first light source is P1, and the irradiation energy of the second light source is P2, then relationships P1<Pc≦P1+P2 and Pcl<P2<Pc are fulfilled.

### CROSS-REFERENCE TO RELATED APPLICATIONS

This application claims priority to Japanese Patent Application No. 2012-103513 filed on Apr. 27, 2012. The entire disclosure of Japanese Patent Application No. 2012-103513 is hereby incorporated herein by reference.

### BACKGROUND

1. Technical Field

The present invention relates to a print apparatus and print method.

2. Background Technology

Inkjet print apparatuses for ejecting ink to print on a medium are known in the art. Such print apparatuses include a print apparatus for ejecting an ink that is cured by being irradiated with light (for example, ultraviolet light (UV), visible light, or the like) (a UV ink). With this type of print apparatus, the UV ink is ejected from a nozzle onto a medium, and thereafter dots that are formed on the medium are irradiated with light. The dots are thereby cured and affixed to the medium (see, for example, Patent Document 1). It is therefore possible to form the dots even on a medium that does not absorb the ink (for example, a film).

Japanese Laid-open Patent Publication No. 2008-265285 (Patent Document 1) is an example of the related art.

### SUMMARY

### Problems to Be Solved by the Invention

With a print apparatus that ejects UV ink, the irradiation of the UV ink with the ultraviolet light is in some instances carried out in two stages. In the first stage, the UV ink on the medium is irradiated with the ultraviolet light to either control the wetting and spreading of the UV ink or to curb bleeding thereof into the UV ink that will be subsequently ejected onto the medium. In the second stage, the medium is irradiated with the ultraviolet light at a more intense irradiation energy (cumulative amount of light) than that of the first stage, to completely cure the UV ink. The first stage is in some instances called “pre-curing” or “pinning”, and the second stage is in some instances called “main curing”.

In main curing, it is necessary for the irradiation energy of the ultraviolet rays to be more intense. As a result, problems have emerged in that the light source for the main curing is greater in size and also in that this results in there being limitations to where the light source for main curing can be installed.

Among inkjet print apparatuses, in some instances a color ink is ejected to form a color image, and also a colorless clear ink is ejected to coat the color image with the clear ink. Whether or not the clear ink is needed is decided depending on the printed article, and therefore preferably the print apparatus is configured so as to allow a user to select as desired to mount a clear head for ejecting the clear ink. In such a case, it would be convenient for a user to be able to utilize the light source without modification irrespective of whether or not there is a clear head.

An advantage of the invention is to provide a print apparatus that makes it possible to mount a clear head as desired, without needing to change a light source, while also reducing in size the light source for main curing.

### Means Used to Solve the Above-Mentioned Problems

A main aspect of the invention for achieving the foregoing advantage is a print apparatus provided with: a conveyance unit for conveying a medium in a conveyance direction; a magenta head for ejecting a magenta ink, which is a color ink that includes a photopolymerization initiator; a cyan head for ejecting a cyan ink, which is a color ink that includes a photopolymerization initiator; a black head for ejecting a black ink, which is a color ink that includes a photopolymerization initiator; a yellow head for ejecting a yellow ink, which is a color ink that includes a photopolymerization initiator; a first light source; a clear head for ejecting a clear ink that includes a photopolymerization initiator; and a second light source; the print apparatus being characterized in that: the first light source is provided further downstream in the conveyance direction than the magenta head, the cyan head, the black head, and the yellow head; the clear head is provided further downstream in the conveyance direction than the first light source; the second light source is provided further downstream in the conveyance direction than the clear head; and, where Pc is an irradiation energy needed for main curing of the color inks, Pcl is an irradiation energy needed for main curing of the clear ink, P1 is an irradiation energy of the first light source, and P2 is an irradiation energy of the second light source, the relationships P1<Pc≦P1+P2 and Pcl<P2<Pc are fulfilled.

Other features of the invention shall be made more readily apparent by the disclosures in the specification and accompanying drawings.

### BRIEF DESCRIPTION OF THE DRAWINGS

Referring now to the attached drawings which form a part of this original disclosure:

FIGS. 1A and 1B are schematic side views of a print apparatus 1 of a first embodiment;

FIG. 2 is a block diagram of the print apparatus 1;

FIG. 3A is a descriptive diagram of a configuration of a black head unit 41k; FIG. 3B is a descriptive diagram of a head assembly 411; and FIG. 3C is a descriptive diagram of the arrangement of nozzles in a head 412;

FIG. 4A is a table of the irradiation energy (cumulative amount of light) needed for main curing of a color ink and of a clear ink; and FIG. 4B is a table of the irradiation intensity (illuminance) and irradiation energy (cumulative amount of light) for each light source;

FIG. 5 is a drawing in which a light source 82 for intense pre-curing and a light source 83 for main curing are viewed from a drum 11 side;

FIG. 6 is a descriptive diagram of a print apparatus 1 of a comparative example; and

FIGS. 7A and 7B are schematic side views of a print apparatus 1 of a second embodiment.

### DETAILED DESCRIPTION OF EXEMPLARY EMBODIMENTS

At least the following features shall be made more readily apparent through the disclosures of this specification and the accompanying drawings.

Made more readily apparent is a print apparatus provided with: a conveyance unit for conveying a medium in a conveyance direction; a magenta head for ejecting a magenta ink, which is a color ink that includes a photopolymerization initiator; a cyan head for ejecting a cyan ink, which is a color ink that includes a photopolymerization initiator; a black head for ejecting a black ink, which is a color ink that includes a photopolymerization initiator; a yellow head for ejecting a yellow ink, which is a color ink that includes a photopolymerization initiator; a first light source; a clear head for ejecting a clear ink that includes a photopolymerization initiator; and a second light source; the print apparatus being characterized in that: the first light source is provided further downstream in the conveyance direction than the magenta head, the cyan head, the black head, and the yellow head; the clear head is provided further downstream in the conveyance direction than the first light source; the second light source is provided further downstream in the conveyance direction than the clear head; and, where Pc is an irradiation energy needed for main curing of the color inks, Pcl is an irradiation energy needed for main curing of the clear ink, P1 is an irradiation energy of the first light source, and P2 is an irradiation energy of the second light source, the relationships P1<Pc≦P1+P2 and Pcl<P2<Pc are fulfilled. According to the print apparatus of such description, it is possible to mount a clear head as desired, without needing to change a light source, while also reducing in size the second light source (the light source for main curing).

Preferably, the yellow head is provided further downstream in the conveyance direction than the magenta head, the cyan head, and the black head, and the print apparatus is provided with: a light source for magenta, provided on the downstream side of the magenta head in the conveyance direction; a light source for cyan, provided on the downstream side of the cyan head in the conveyance direction; and a light source for black, provided on the downstream side of the black head in the conveyance direction; the first light source irradiating light at a more intense irradiation energy than irradiation energies of the light source for magenta, the light source for cyan, and the light source for black. This makes it possible to curb the occurrence of surface wrinkling of the yellow dots.

Preferably, the conveyance unit has a drum for conveying the medium by rotating, and the magenta head, the cyan head, the black head, the yellow head, the first light source, the clear head, and the second light source are provided along the surface of the drum. This reduces the length of a conveyance route.

Preferably, the first light source and the second light source are constituted of a light-emitting diode (LED). This causes the irradiation intensity of the second light source to be of the same magnitude as the irradiation intensity of the first light source.

Made more readily apparent is a print apparatus provided with: a conveyance unit for conveying a medium in a conveyance direction; a magenta head for ejecting a magenta ink, which is a color ink that includes a photopolymerization initiator; a cyan head for ejecting a cyan ink, which is a color ink that includes a photopolymerization initiator; a black head for ejecting a black ink, which is a color ink that includes a photopolymerization initiator; a yellow head for ejecting a yellow ink, which is a color ink that includes a photopolymerization initiator; a first light source; a clear head for ejecting a clear ink that includes a photopolymerization initiator; and a second light source; the print apparatus being characterized in that: the first light source is provided further downstream in the conveyance direction than the magenta head, the cyan head, the black head, and the yellow head; the clear head is provided further downstream in the conveyance direction than the first light source; the second light source is provided further downstream in the conveyance direction than the clear head; and, where L1 is the length of the first light source in the conveyance direction and L2 is the length of the second light source in the conveyance direction, and where Lc is the length in the conveyance direction of a light source needed for main curing of the color links and Lcl is the length in the conveyance direction of a light source needed for main curing of the clear ink in a case where the medium is conveyed at a predetermined conveyance speed and light is irradiated from the first light source and from the second light source at a predetermined irradiation intensity, the relationships L1<Lc≦L1+L2 and Lcl<L2<Lc are fulfilled. According to the print apparatus of such description, it is possible to mount a clear head as desired, without needing to change a light source, while also reducing in size the second light source (the light source for main curing).

Made more readily apparent is a print method using: a conveyance unit for conveying a medium in a conveyance direction; a magenta head for ejecting a magenta ink, which is a color ink that includes a photopolymerization initiator; a cyan head for ejecting a cyan ink, which is a color ink that includes a photopolymerization initiator; a black head for ejecting a black ink, which is a color ink that includes a photopolymerization initiator; a yellow head for ejecting a yellow ink, which is a color ink that includes a photopolymerization initiator; a first light source; a clear head for ejecting a clear ink that includes a photopolymerization initiator; and a second light source; the print method being characterized in that: the first light source is provided further downstream in the conveyance direction than the magenta head, the cyan head, the black head, and the yellow head; the clear head is provided further downstream in the conveyance direction than the first light source; the second light source is provided further downstream in the conveyance direction than the clear head; and, where Pc is an irradiation energy needed for main curing of the color inks, NI is an irradiation energy needed for main curing of the clear ink, P1 is an irradiation energy of the first light source, and P2 is an irradiation energy of the second light source, the relationships P1<Pc≦P1+P2 and Pcl<P2<Pc are fulfilled. According to the print method of such description, it is possible to mount a clear head as desired, without needing to change a light source, while also reducing in size the second light source (the light source for main curing).

Made more readily apparent is a print method using: a conveyance unit for conveying a medium in a conveyance direction; a magenta head for ejecting a magenta ink, which is a color ink that includes a photopolymerization initiator; a cyan head for ejecting a cyan ink, which is a color ink that includes a photopolymerization initiator; a black head for ejecting a black ink, which is a color ink that includes a photopolymerization initiator; a yellow head for ejecting a yellow ink, which is a color ink that includes a photopolymerization initiator; a first light source; a clear head for ejecting a clear ink that includes a photopolymerization initiator; and a second light source; the print method being characterized in that: the first light source is provided further downstream in the conveyance direction than the magenta head, the cyan head, the black head, and the yellow head; the clear head is provided further downstream in the conveyance direction than the first light source; the second light source is provided further downstream in the conveyance direction than the clear head; and, where L1 is the length of the first light source in the conveyance direction and L2 is the length of the second light source in the conveyance direction, and where Lc is the length in the conveyance direction of a light source needed for main curing of the color links and Lcl is the length in the conveyance direction of a light source needed for main curing of the clear ink in a case where the medium is conveyed at a predetermined conveyance speed and light is irradiated from the first light source and from the second light source at a predetermined irradiation intensity, the relationships L1<Lc≦L1+L2 and Lcl<L2<Lc are fulfilled. According to the print method of such description, it is possible to mount a clear head as desired, without needing to change a light source, while also reducing in size the second light source (the light source for main curing).

### First Embodiment

### <Summary of the Print Apparatus>

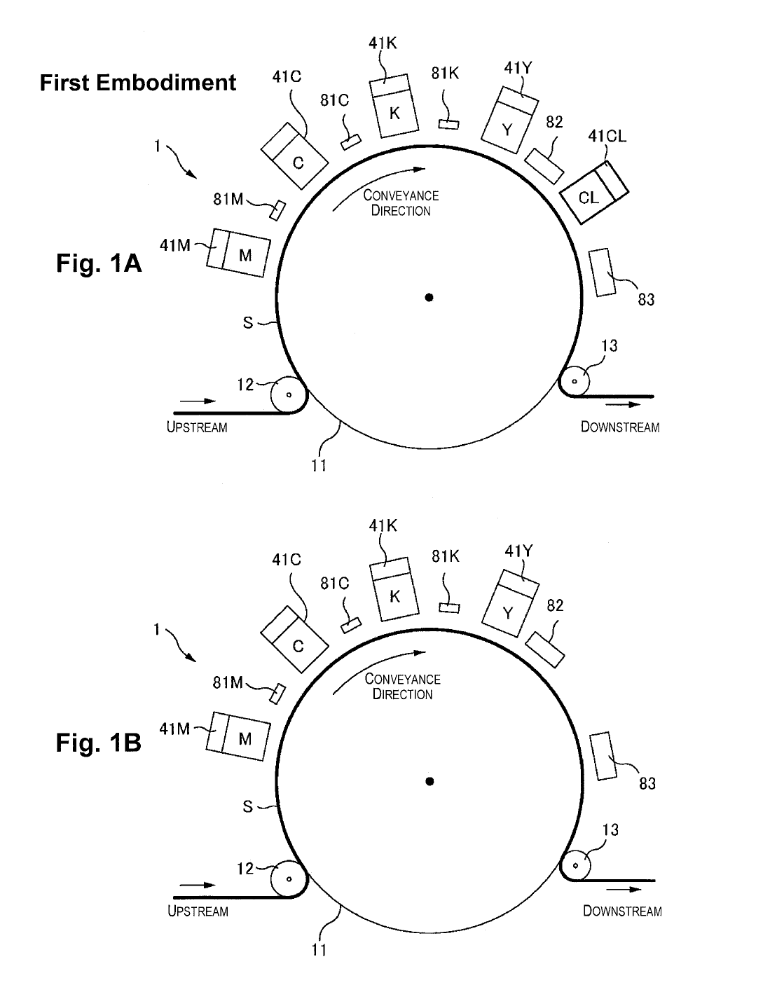

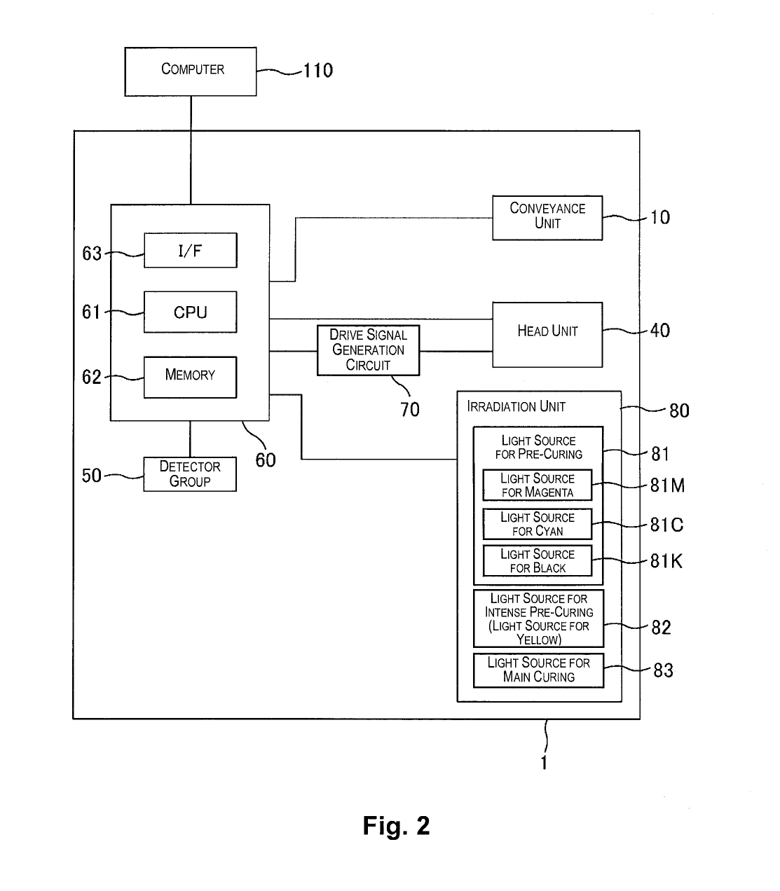

FIGS. 1A and 1B are schematic side views of the print apparatus 1 of the first embodiment. FIG. 2 is a block diagram of the print apparatus 1.

The print apparatus 1 is provided with a conveyance unit 10, a head unit 40, a detector group 50, a controller 60, a drive signal generation circuit 70, and an irradiation unit 80.

The conveyance unit 10 has a function for conveying a medium. In the description that follows, the direction in which the medium is conveyed shall be called the conveyance direction. The conveyance unit 10 has a drum 11, an upstream roller 12, and a downstream roller 13. The medium is supplied from a supply unit (not shown) on the upstream side of the conveyance unit 10, and is taken up by a take-up roller (not shown) on the downstream side of the conveyance unit 10. The medium is stretched at a predetermined tension from the upstream roller 12 to the downstream roller 13, and is in intimate contact with the surface of the drum 11. The drum 11 rotates and the medium is thereby conveyed. The medium is in some instances paper, but in other instances is a translucent medium S.

The head unit 40 has a magenta head unit 41M, a cyan head unit 41C, a black head unit 41K, a yellow head unit 41Y, and a clear head unit 41CL, in the stated order from the upstream side in the conveyance direction. Each of the head units 41 is provided along the surface of the drum 11. Each of the head units 41 ejects a UV ink. The UV ink is an ink that includes a photopolymerization initiator, and is an ink that has the property of being cured when irradiated with ultraviolet light. The composition of the UV inks shall be described below.

The magenta head unit 41M ejects a magenta ink. The cyan head unit 41C ejects a cyan ink. The black head unit 41K ejects a black ink. The yellow head unit 41Y ejects a yellow ink. The magenta ink, the cyan ink, and the yellow ink print a color image by a subtractive color technique. The black ink is also used to print a color image. In the description that follows, the term “color ink(s)” is used to refer to the magenta ink, the cyan ink, the yellow ink, and the black ink.

It should be noted that the magenta ink has a property where a color material for absorbing a predetermined wavelength and coloring to magenta is not easily broken with ultraviolet light. For this reason, in the present embodiment, the magenta head unit 41M is arranged further upstream in the conveyance direction than the other head units for ejecting the other color inks. In a case where, the head unit for magenta as one of the three primary colors of the subtractive color technique is arranged on the most upstream side, then normally the head units for the remaining two primary colors (the cyan head unit 41C and the yellow head unit 41Y) are arranged next, and finally the black head unit 41K, which is not one of the three primary colors, is arranged. However, in the present embodiment, regardless of the fact that the magenta head unit 41M is arranged at the most upstream side, the yellow head unit 41Y is arranged further downstream in the conveyance direction than the black head unit 41K.

The clear head unit 41CL ejects a clear ink. The clear ink is a colorless, translucent ink with which the surface of the color image is coated in order to adjust the glossiness of the color image or in order to form a protective film on the surface of the color image, and generally is an ink that does not include a coloring material such as a pigment or dye. Being colorless and translucent, the clear ink is therefore a different ink than the color inks that are used to print the color image. The clear ink of the present embodiment, too, is an ink that includes a photopolymerization initiator, and is constituted of a UV ink that is cured when irradiated with ultraviolet light.

The print apparatus 1 comes standardly equipped with the head units 41 for ejecting the color inks (the magenta head unit 41M, the cyan head unit 41C, the black head unit 41K, and the yellow head unit 41Y). In contrast, the clear head unit 41CL is equipped as an option, as will be readily understood by comparing FIGS. 1A and 1B, and the user is able to select whether or not the print apparatus 1 is equipped with same as desired. In other words, the print apparatus 1 is able to print using the clear ink when loaded with the clear head unit 41CL and is also able to print without using the clear ink when not loaded with the clear head unit 41CL.

The clear head unit 41CL is provided further downstream in the conveyance direction than the head units for ejecting the color inks. This is because the clear ink is an ink with which the color image is to be coated. As such, the clear head unit 41CL would be provided further downstream in the conveyance direction than the yellow head unit 41Y. The clear head unit 41CL is also provided further downstream in the conveyance direction than a light source 82 for intense pre-curing (described below).

The provision of a head unit(s) further downstream in the conveyance direction than the head units for ejecting the color inks is not limited to the clear head unit 41CL. Instead of the clear head unit 41CL, a specialty color head unit for ejecting a desired specialty color ink can be provided. Specific examples of specialty color inks include white ink, metallic ink, orange ink, vivid pink ink, or the like. These specialty color inks, too, are constituted of a UV ink that is cured when irradiated with ultraviolet light.

The detector group 50 is an expression for a variety of detectors for detecting information about each of the parts of the print apparatus 1. For example, included in the detector group 50 are an encoder (not shown) for detecting the angle of rotation of the drum, and the like. The detector group 50 sends a detection signal to the controller 60.

The controller 60 is a control unit for controlling the print apparatus 1. The controller 60 has a CPU 61, a memory 62, and an interface unit 63. The CPU 61 is a computation processing device for controlling the entirety of the print apparatus 1. The memory 62 is a storage unit for maintaining a work region for the CPU 61, a region for storing a program, and the like. The CPU 61 is intended to control each of the units in accordance with a program that is stored in the memory 62. The interface unit 63 sends and receives data between the print apparatus 1 and a computer 11, which is an external device.

The drive signal generation circuit 70 is a circuit for generating a drive signal for driving a drive element, such as a piezoelectric element, included in the head units 40. The application of the drive signal to the drive element causes the drive element to be driven and causes ink droplets to be ejected from the nozzles.

The irradiation unit 80 is a unit for irradiating with the ultraviolet light for curing the UV inks. The illumination unit 80 has light sources 81 for pre-curing, a light source 82 for intense pre-curing, and a light source 83 for main curing.

The term “main curing” refers to curing the dots formed on the medium until a state of curing that is needed for the printed article to be used. The term “pre-curing” signifies temporary fixing of the ink (pinning), and refers to curing in advance of main curing in order to prevent bleeding or color mixing of the dots; generally, the conversion rate in the pre-curing is lower than the conversion rate caused by the main curing that is carried out after the pre-curing. The term “conversion rate” signifies the rate at which the polymerizable compounds included in the ink composition are converted to a cured product, and is another manner of referring to the degree of curing of the ink composition caused by being irradiated with light. The term “intense pre-curing” signifies pre-curing of a higher degree of curing than ordinary “pre-curing”, and is also called “intense pinning”.

The light sources 81 for pre-curing are light sources for irradiating with ultraviolet light at a level of irradiation energy adequate for curing the surface of the UV ink (the pre-curing) so as to prevent bleeding of the UV inks that have been deposited onto the medium. The light sources 81 for pre-curing irradiate with ultraviolet light of irradiation energy that is weak enough to not cause main curing of the UV ink. This is because main curing of the UV ink has the property of resulting in shedding of the ink, and results in shedding of the color inks with which same is subsequently coated, whereupon the color image can suffer a decline in image quality.

The irradiation energy (cumulative amount of light) [mJ/cm²] is calculated from the product of the irradiation intensity (illuminance) [mW/cm²] at an irradiated surface being irradiated by the light source and the irradiation time [s]. When the irradiation energy is higher, the conversion rate of the polymerizable compounds included in the UV inks is higher and the UV inks are more cured.

The light sources 81 for pre-curing include a light source 81M for magenta, a light source 81C for cyan, and a light source 81K for black, in the stated order from the upstream side in the conveyance direction. No light source for yellow, however, is provided as a light source 81 for pre-curing (instead, the yellow ink will be cured by the light source 82 for intense pre-curing).

The light sources 81 for pre-curing are provided along the surface of the drum 11. The light sources 81 for pre-curing are provided on the downstream side in the conveyance direction of the head unit 41 of the corresponding color. For example, the light source 81M for magenta is provided to the downstream side in the conveyance direction of the magenta head unit 41M. The UV inks, having been deposited onto the medium and formed dots, are thereby immediately thereafter irradiated with ultraviolet light from the light source 81 for pre-curing, and the dot surface of the UV inks is pre-cured. The light sources 81 for pre-curing are configured using light-emitting diodes (LEDs).

No light source for yellow is provided as a light source 81 for pre-curing. The reason for this is that the UV ink for the yellow more readily absorbs the ultraviolet light than do the UV inks for the cyan and magenta, and therefore irradiating the yellow ink with the ultraviolet light for ordinary pre-curing (the ultraviolet light of the comparatively weaker irradiation energy) results in the ultraviolet light being absorbed by the surface of the yellow ink, and in some instances the ultraviolet light cannot reach the interior of the yellow ink. When the yellow ink is irradiated with ultraviolet light at an equivalent level of irradiation energy as that of the light sources 81 for pre-curing, solely the surface is cured, and the interior remains fluid. When the yellow ink in this state is irradiated with the ultraviolet light for main curing (the ultraviolet light of a higher irradiation energy) for main-curing of the yellow ink, the yellow ink at the interior is cured and shrinks, and this results in the occurrence of wrinkling at the surface of the yellow ink (the surface having already been cured). When wrinkling occurs on the surface of dots of a color as bright as yellow, the shading caused by the wrinkling is easily visible, and there is a decline in the image quality. In light of such reasons, in the present embodiment, no light source for yellow is provided as a light source 81 for pre-curing, and instead the light source 82 for intense pre-curing is provided.

The light source 82 for intense pre-curing is a light source for irradiating with ultraviolet light at a higher irradiation energy than that of the light sources 81 for pre-curing (the light source 81M for magenta, the light source 81C for cyan, the light source 81K for black). The yellow dots are thereby pre-cured (intense pre-curing; intense pinning) at a higher degree of curing (higher conversion rate) than that of the ordinary pre-curing. The ultraviolet light can reach the interior of the yellow dots, and the occurrence of wrinkling of the yellow dots can be minimized.

The light source 82 for intense pre-curing irradiates with ultraviolet light of a weak enough irradiation energy that the color inks will not undergo main curing. This is in order to minimize as much as possible the result of shedding of the clear ink with which same is subsequently coated. Because the light source 82 for intense pre-curing pre-cures the yellow dots, bleeding of the yellow dots with the clear ink is minimized.

The light source 82 for intense pre-curing, which irradiates with ultraviolet light of a comparatively more stronger irradiation energy, in some instances can accordingly have the property of causing the yellow dots to shed an ink. However, at this stage all of the color dots have been formed (the color image is completed), and no more color ink will be applied at a later time, and thus there is no concern that the color inks will be shed nor that there will be a decline in image quality. The clear ink that is applied after the intense pre-curing of the yellow dots is a colorless, translucent ink, and is an ink that is applied uniformly so as to coat the surface of the color image, and therefore there is little impact on the image quality of the color image even when it is somewhat shed by the yellow ink. For this reason, it is permissible for the light source 82 for intense pre-curing to irradiate with ultraviolet light at the comparatively higher irradiation energy.

The light source 82 for intense pre-curing is provided along the surface of the drum 11. The light source 82 for intense pre-curing is provided on the downstream side in the conveyance direction of the yellow head unit 41Y. The light source 82 for intense pre-curing is configured by using a LED. The light source 82 for intense pre-curing is equivalent to the first light source that is provided to the downstream side in the conveyance direction of the color heads and that irradiates with light.

The light source 83 for main curing is a light source for irradiated with ultraviolet light for main curing (complete solidification) of the UV inks on the medium. The light source 83 for main curing irradiates with ultraviolet light at a higher irradiation energy than those of the light sources 81 for pre-curing 81 and of the light source 82 for intense pre-curing.

In the present embodiment, the light source 83 for main curing is provided along the surface of the drum 11, and is provided to the downstream side in the conveyance direction of the clear head unit 41CL. The light source 83 for main curing is configured by using an LED, similarly with respect to the light sources 81 for pre-curing and the light source 82 for intense pre-curing. The light source 83 for main curing is equivalent to the second light source that is provided to the downstream side in the conveyance direction of the clear head and that irradiates with light.

### <Configuration of the Head Units>

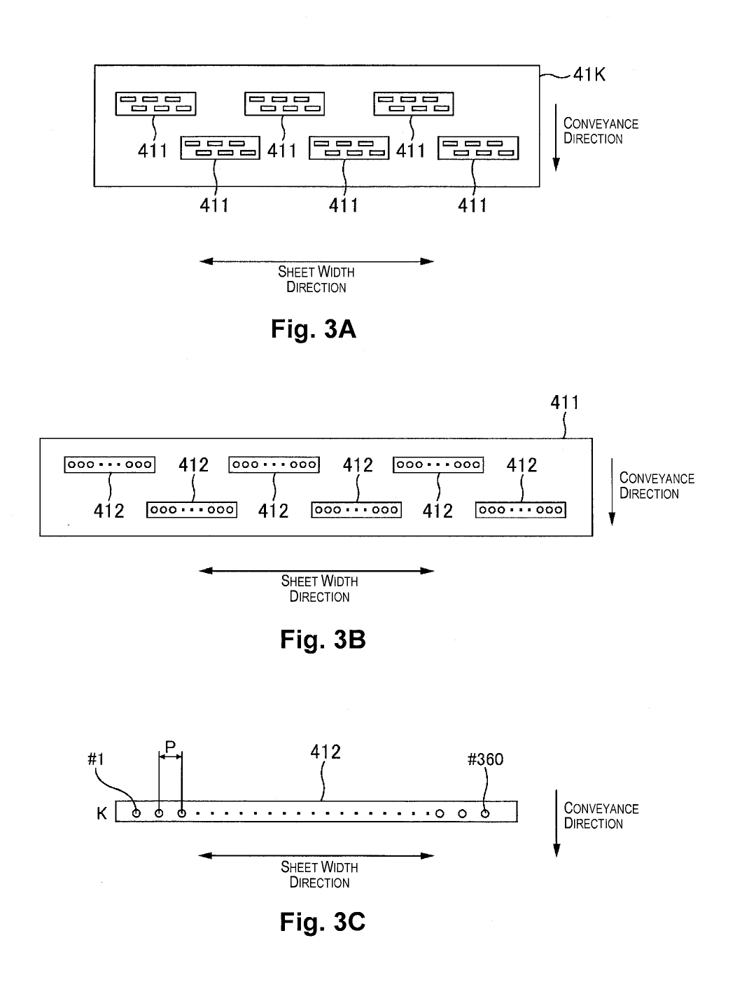

FIG. 3A is a descriptive diagram of a configuration of the black head unit 41K. The description herein relates to the black head unit 41K, but the same is also true of the configurations for the head units of the other colors.

The black head unit 41K has six head assemblies 411. The six head assemblies 411 are arranged in a staggered manner along the sheet width direction. That is, there are three head assemblies 411 on the upstream side in the conveyance direction and three head assemblies 411 on the downstream side, all of which are arranged so as to be alternately shifted in the sheet width direction.

FIG. 3B is a descriptive diagram of a head assembly 411. The head assembly 411 has six heads 412. The six heads 412 are arranged in a staggered manner along the sheet width direction. That is, there are three heads 412 on the upstream side in the conveyance direction and three heads 412 on the downstream side, all of which are arranged so as to be alternately shifted in the sheet width direction.

FIG. 3C is a descriptive diagram of the arrangement of nozzles in a head 412. The head 412 has 360 nozzles. The 360 nozzles are arranged in one row along the sheet width direction, and constitute a nozzle row. The 360 nozzles are arranged side by side at a 1/360-inch interval (a nozzle pitch).

This manner of configuring the black head unit 41K causes the plurality of nozzles belonging to the black head unit 41K to be arranged side by side in the sheet width direction at substantially a 1/360-inch interval. This makes it possible for the black head unit 41K to form the dots on the medium at a 1/360-inch interval (a dot pitch). However, rather than the six head assemblies being arranged in a staggered manner, there can instead be 36 heads 412 arranged in a staggered manner. In brief, the plurality of nozzles should be arranged side by side in the sheet width direction at substantially a predetermined nozzle pitch.

### <Print Method>

The print apparatus 1 conveys the medium on the conveyance unit 10, ejects the magenta ink from the magenta head unit 41M to form the magenta dots on the medium while the medium is being conveyed, irradiates the magenta dots with the ultraviolet light from the light source 81M for magenta, and pre-cures the magenta dots.

When the print apparatus 1 continues the conveyance of the medium, the portion where the magenta dots have been formed (a region where a magenta image has been formed) reaches the cyan head unit 41C. The print apparatus 1 ejects the cyan ink from the cyan head unit 41C to form the cyan dots on the medium while the medium is being conveyed. Because the magenta dots have already been pre-cured, bleeding between the magenta dots and the cyan dots will not take place. The print apparatus 1 irradiates with the ultraviolet light from the light source 81C for cyan to pre-cure the cyan dots.

When the print apparatus 1 continues the conveyance of the medium, the portion where the magenta dots and the cyan dots have been formed (a region where a magenta image and a cyan image have been formed) reaches the black head unit 41C. The print apparatus 1 ejects the black ink from the black head unit 41K to form the black dots on the medium while the medium is being conveyed. Because the magenta dots and the cyan dots have already been pre-cured, bleeding between the black dots and the other dots will not take place. The print apparatus 1 irradiates with the ultraviolet light from the light source 81K for black to pre-cure the black dots.

In the present embodiment, before the yellow dots are formed, the color dots of the other colors (magenta, cyan, black) are formed and the dots thereof are pre-cured. It is in order to do this that, in the present embodiment, the yellow head unit 41Y is arranged further downstream in the conveyance direction than the head units for ejecting the color inks of the other colors and than the light sources for pre-curing corresponding to these head units. This avoids irradiation of the yellow ink with the ultraviolet light for ordinary pre-curing.

When the print apparatus 1 continues the conveyance of the medium, the portion where the magenta dots, the cyan dots, and the black dots have been formed (a region where a magenta image, a cyan image, and a black image have been formed) reaches the yellow head unit 41Y. The print apparatus 1 ejects the yellow ink from the yellow head unit 41Y to form the yellow dots on the medium while the medium is being conveyed. Because the color dots of the other colors have already been pre-cured, bleeding between the yellow dots and the other dots will not take place.

In the present embodiment, no light source for yellow is provided as a light source 81 for pre-curing. For this reason, the yellow dots are not irradiated with an ultraviolet light for ordinary pre-curing (ultraviolet light of a comparatively weaker irradiation energy). Instead, the printer apparatus irradiates with ultraviolet light from the light source 82 for intense pre-curing to pre-cure the yellow dots. The light source 82 for intense pre-curing irradiates with ultraviolet light of a higher irradiation energy than that of the light sources 81 for pre-curing, and thus the ultraviolet light can reach the interior of the yellow dots and the occurrence of wrinkling of the yellow dots can be minimized.

In a case where the print apparatus 1 comes optionally equipped with the clear head unit 41CL (see FIG. 1A), when the print apparatus 1 further continues the conveyance of the medium, the portion where the color dots have been formed (the region where the color image has been formed) reaches the clear head unit 41CL. The print apparatus 1 ejects the clear ink from the clear head unit 41CL while the medium is being conveyed and applies the clear ink uniformly so as to cover the surface of the color image. Because the color dots have already been pre-cured (intensely pre-cured), bleeding between the clear ink and the color dots will not take place.

When the print apparatus 1 continues the conveyance of the medium, a portion coated with the clear ink (or, in a case where the print apparatus 1 does not come equipped with the clear head unit CL, as in FIG. 1B, is the region where the color image has been formed) is irradiated with ultraviolet light by the light source 83 for main curing and undergoes main curing, and a print image is thus printed onto the medium.

### <Irradiation Energy Needed for Main Curing and Irradiation Energies of the Light Sources>

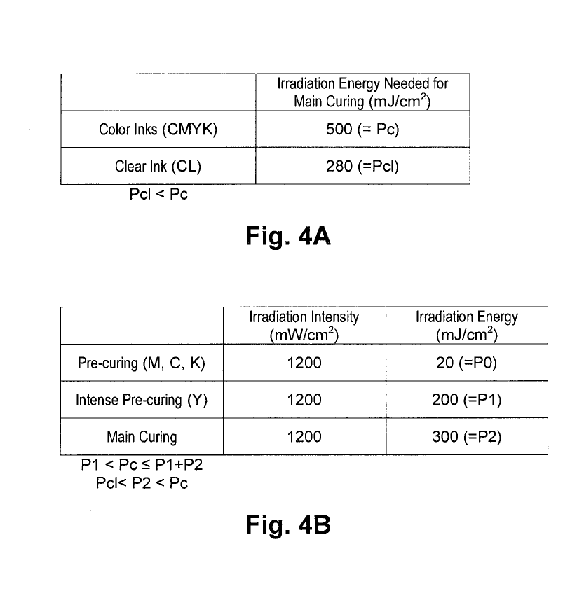

FIG. 4A is a table of the irradiation energy (cumulative amount of light) needed for the main curing of the color inks and of the clear ink. The irradiation energy (cumulative amount of ink) needed for the main curing of the color inks is not less than 500 mJ/cm². The irradiation energy needed for the main curing of the clear ink is not less than 280 mJ/cm². The compositions of the UV inks of the present embodiment are as illustrated in table 1 below.

The clear ink requires less irradiation energy for main curing than the color inks. In other words, where the irradiation energy needed for the main curing of the color inks is Pc and the irradiation energy needed for the main curing of the clear ink is Pcl, then Pcl<Pc. This reason for this is believed to be that because the clear ink does not include a coloring material as the color inks do, there is no absorption of the ultraviolet light by the coloring material.

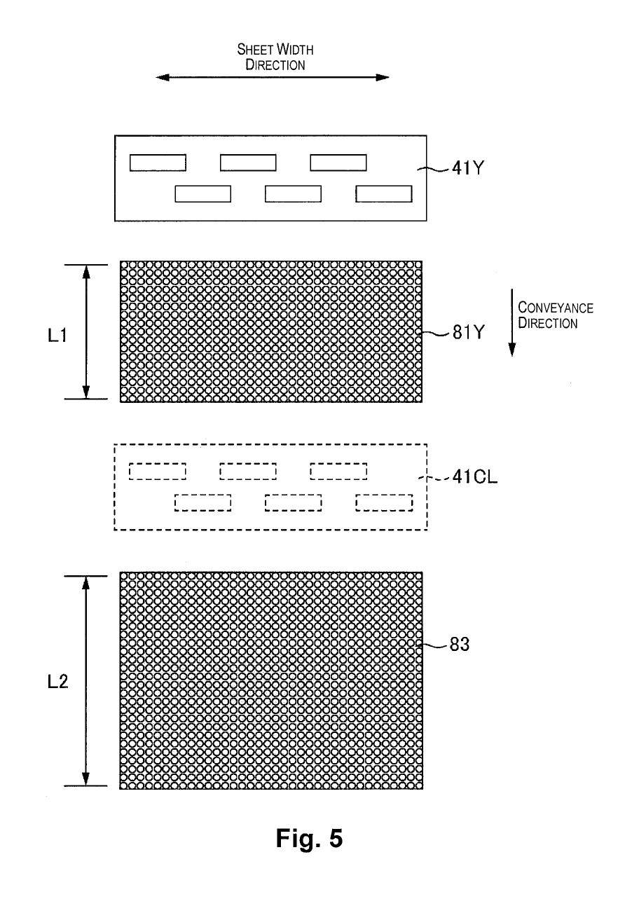

FIG. 4B is a table of the irradiation intensity (illuminance) and irradiation energy (cumulative amount of light) for each of the light sources. In the present embodiment, the same LED is employed for all of the light sources, and the electrical currents flowing through the LEDs are all the same, and therefore all light sources have the same irradiation energy (1200 mW/cm²). However, because each of the light sources has a different length in the conveyance direction (see FIG. 5), each of the light sources has a different irradiation duration, and each of the light sources has a different irradiation energy.

More specifically, the irradiation energy of the light sources 81 for pre-curing (the light source 81M for magenta, the light source 81C for cyan, and the light source 81K for black) is 20 mJ/cm² for each. The irradiation energy of the light source 82 for intense pre-curing is 200 mJ/cm². The irradiation energy of the light source 83 for main curing is 300 mJ/cm².

In the present embodiment, where the irradiation energy of the light source 82 for intense pre-curing is P1 (=200 mJ/cm²) and the irradiation energy of the light source 83 for main curing is P2 (=300 mJ/cm²), the irradiation energy Pc that is needed for the main curing of the color inks (=500 mJ/cm²) fulfills a relationship P1<Pc≦P1+P2. Because the relationship is P1<Pc, the color dots (in particular, the yellow dots that are formed last) do not undergo main curing at the stage where the color dots are irradiated with the ultraviolet light from the light source 82 for intense pre-curing). For this reason, because the clear ink is applied before the color dots undergo the main curing, shedding of the clear ink by the color dots is minimized. In turn, because the relationship is Pc≦P1+P2, the color dots undergo the main curing upon being irradiated with the ultraviolet light from the light source 83 for main curing. For this reason, printing is not completed in a state where the color dots have not undergone the main curing.

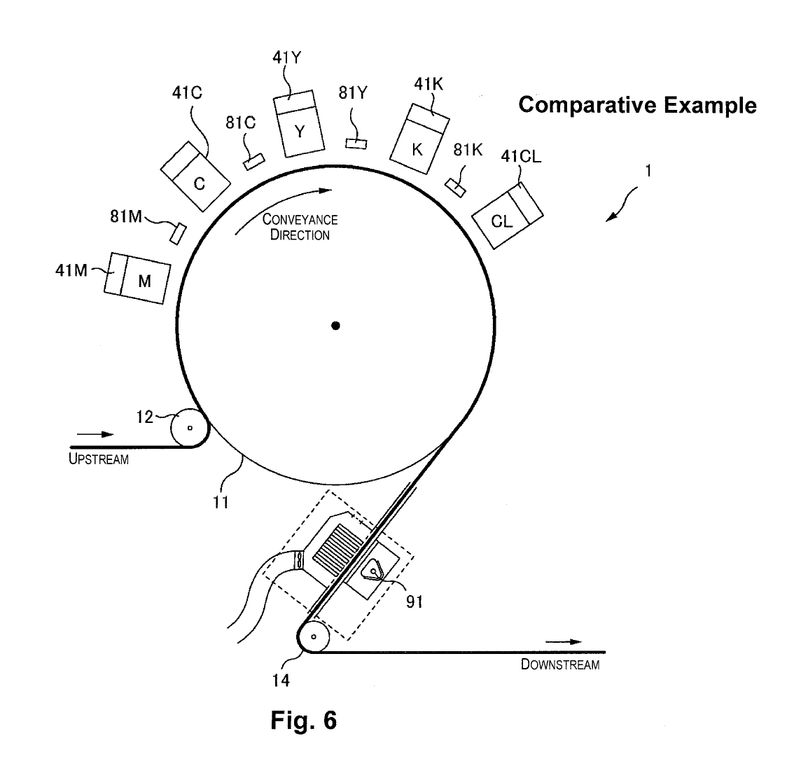

In the present embodiment, where the irradiation energy needed for the main curing of the color inks is Pc (=500 mJ/cm²) and the irradiation energy needed for the main curing of the clear ink is Pcl (=280 mJ/cm²), the irradiation energy P2 of the light source 83 for main curing=300 mJ/cm²) fulfills a relationship Pcl<P2<Pc. Because the relationship is Pcl<P2, the clear dots undergo the main curing upon being irradiated with the ultraviolet light from the light source 83 for main curing. For this reason, printing is not completed in a state where the clear dots have not undergone the main curing. In turn, because the relationship is P2<Pc, the light source 83 for main curing can be constituted of a light source of lower irradiation energy, and the light source 83 for main curing can be reduced in size. The light source 83 for main curing of the present embodiment can be provided along the surface of the drum 11, unlike the light source for main curing of a comparative example described below (see FIG. 6). Because the color dots are irradiated with the ultraviolet light from the light source 82 for intense pre-curing before being irradiated with the ultraviolet light from the light source 83 for main curing, the color dots undergo the main curing upon being irradiated with the ultraviolet light from the light source 83 for main curing even with the relationship P2<Pc.

As per the foregoing, in the present embodiment, where the irradiation energy of the light source 82 for intense pre-curing is P1, the irradiation energy of the light source 83 for main curing is P2, the irradiation energy needed for the main curing of the color inks is Pc, and the irradiation energy needed for the main curing of the clear ink is Pcl, the relationships P1<Pc≦P1+P2 and Pcl<P2<Pc are fulfilled. This makes it possible for the clear head unit to be equipped as an option, without the need to change the light sources, while also reducing the light source 83 for main curing in size.

The light source 83 for main curing of the present embodiment is provided along the surface of the drum together with the color head units (41M, 41C, 41K, 41Y), the light source 82 for intense pre-curing, and the clear head unit 41CL. This makes it possible to shorten the conveyance route, unlike the comparative example described below (see FIG. 6).

In the present embodiment, where the ordinary irradiation energy of the light sources 81 for pre-curing is P0 (=20 mJ/cm²) and the number of instances where the first color dots to be formed (herein, the magenta dots) are irradiated with the ultraviolet light from the light sources 81 for pre-curing is n (=3 times), then a relationship P0×n+P1<Pc is fulfilled. For this reason, the first color dots to be formed do not undergo main curing at the stage where the dots are irradiated with the ultraviolet light from the light source 82 for intense pre-curing. Shedding of the clear ink by the color dots is thereby minimized, because the clear ink is applied before the color dots undergo the main curing.

### <Relationships in the Lengths L of the Light Sources in the Conveyance Direction>

FIG. 5 is a drawing in which the light source 82 for intense pre-curing and the light source 83 for main curing are viewed from the drum 11 side. The yellow head unit 41Y is on the upstream side in the conveyance direction of the light source 82 for intense pre-curing. The optionally equipped clear head unit 41CL is denoted by the dotted line between the light source 82 for intense pre-curing and the light source 83 for main curing.

A plurality of LEDs are arranged in two dimensions on lower surfaces of the light source 82 for intense pre-curing and the light source 83 for main curing. Electrical currents of equivalent levels flow to the LEDs, and thus the irradiation intensity (illuminance) of the ultraviolet light of the light source 83 for main curing [mW/cm²] is substantially the same as the irradiation intensity of the ultraviolet light of the light source 82 for intense pre-curing (and of the light sources 81 for pre-curing).

Where the length of the light source 82 for intense pre-curing in the conveyance direction is L1 and the length of the light source 83 for main curing in the conveyance direction is L2, then the configuration is such that L1:L2=200:300. This makes it possible for P1:P2=200:300, where P1 is the irradiation energy of the light source 82 for intense pre-curing and P2 is the irradiation energy of the light source 83 for main curing. Then, having the conveyance speed be a predetermined speed makes it possible to have the irradiation energy of the light source 83 for main curing be 300 mJ/cm² while also having the irradiation energy of the light source 82 for intense pre-curing be 200 mJ/cm².

In FIG. 5, each of the light sources is constituted of a single unit. The light sources can, however, be in some instances constituted by arranging a plurality of small individual units side by side. In such a case, the phrase “the lengths L of the light sources in the conveyance direction” would refer to the sums of the lengths in the conveyance direction of the individual units arranged side by side in the conveyance direction.

In the present embodiment, all of the light sources are of the same irradiation intensity (see FIG. 4B). For this reason, when the irradiation energies P [mJ/cm²] needed for main curing of the inks illustrated in FIG. 4A are divided by the irradiation intensities E [mW/cm²], it is possible to calculate the irradiation durations T [s] of the ultraviolet light needed for the main curing of the inks. Additionally, because the conveyance speed V [cm/s] of the medium is already known, when the irradiation durations T [s] needed for the main curing of the inks are divided by the conveyance speed V [cm/s] of the medium, it is possible to calculate the lengths [cm] of the light sources in the conveyance direction needed for the main curing of the inks.

Then, in the present embodiment, where the length of the light source 82 for intense pre-curing in the conveyance direction is L1 and the length of the light source 83 for main curing in the conveyance direction is L2, a length Lc of the light sources in the conveyance direction needed for the main curing of the color inks fulfills a relationship L1<Lc≦L1+L2. Because the relationship is L1<Lc, the color dots (in particular, the yellow dots, which are the last to be formed) do not undergo the main curing at the stage where the dots are irradiated with the ultraviolet light from the light source 82 for intense pre-curing. For this reason, because the clear ink is applied before the color dots undergo the main curing, shedding of the clear ink by the color dots is minimized. In turn, because the relationship is Lc≦L1+L2, the color dots undergo the main curing upon being irradiated with the ultraviolet light from the light source 83 for main curing. For this reason, printing is not completed in a state where the color dots have not undergone the main curing.

In the present embodiment, where the length of the light sources in the conveyance direction needed for the main curing of the color inks is Lc and the length of the light sources in the conveyance direction needed for the main curing of the clear ink is Lcl, the length L2 of the light source 83 for main curing in the conveyance direction fulfills the relationship Lcl<L2<Lc. Because the relationship has Lcl<L2, the clear dots undergo the main curing upon being irradiated with the ultraviolet light from the light source 83 for main curing. For this reason, printing is not completed in a state where the clear dots have not undergone the main curing. In turn, because the relationship has L2<Lc, a shorter length in the conveyance direction can be configured for the light source 83 for main curing. Because the color dots are irradiated with the ultraviolet light from the light source 82 for intense pre-curing before being irradiated with the ultraviolet light from the light source 83 for main curing, the color dots undergo the main curing upon being irradiated with the ultraviolet light from the light source 83 for main curing even with the relationship L2<Lc.

As per the foregoing, in the present embodiment, in a case where the length of the light source 82 for intense pre-curing in the conveyance direction is L1, the length of the light source 83 for main curing in the conveyance direction is L2 and the light is irradiated from the light sources at a predetermined conveyance speed V and a predetermined irradiation intensity, then when the length of the light sources in the conveyance direction needed for the main curing of the color inks is Lc and the length of the light sources in the conveyance direction needed for the main curing of the clear ink is Lcl, the relationships L1<Lc≦L1+L2 and Lcl<L2<Lc are fulfilled. This makes it possible for the clear head unit to be equipped as an option, without the need to change the light sources, while also reducing the light source 82 for main curing in size.

### Comparative Example

FIG. 6 is a descriptive diagram of a print apparatus 1 of the comparative example.

In the comparative example, a metal halide lamp is employed as a light source 91 for main curing. The light source 91 for main curing is also provided with: a reflecting mirror for reflecting the ultraviolet light from the metal halide lamp 91 toward the medium; a fin, a fan, and a duct for drawing off heat; and the like.

In the comparative example, an irradiation energy P_91 of the light source 91 for main curing has the relationships Pc<P_91 and Pcl<P_91 with respect to the irradiation energy Pc needed for the main curing of the color inks and the irradiation energy Pcl needed for the main curing of the clear ink. For this reason, the color dots and the clear dots undergo the main curing upon being irradiated with the ultraviolet light from the light source 91 for main curing. However, in the comparative example, because the irradiation energy of the light source 91 for main curing is higher, the result is that the light source is larger in size in comparison to the light source 83 for main curing of the present embodiment. Also, were the light source 91 for main curing of the powerful irradiation energy to be provisionally provided along the surface of the drum, the result would be that the drum 11 is heated to an excessive degree. For this reason, in the comparative example, the light source 91 for main curing must be provided at a position not facing the drum 11, in order to prevent heating of the drum. Thus, in the case where the irradiation energy of the light source 91 for main curing is powerful, the result is that there are limitations to where the light source 91 for main curing can be installed. As a consequence, in the comparative example, the conveyance route for the medium is longer.

The reason for which the comparative example results in an increase in size for the light source 91 for main curing is that the irradiation energy for the light source 91 for main curing has been set without the use of having a weaker irradiation energy needed for the main curing of the clear ink than for the color inks (Pcl<Pc). By contrast, in the present embodiment, the irradiation energy P2 of the light source 83 for main curing has been set to the relationship Pcl<P2<Pc by using the fact that the optionally equipped clear head unit 41Cl is provided further downstream in the conveyance direction than the color head units (in order words, the clear ink is ejected after the color inks are) and the fact that Pcl<Pc. This makes it possible in the present embodiment for the light source 83 for main curing to be reduced in size.

In the comparative example, the yellow head unit 41Y is provided further upstream in the conveyance direction than the black head unit 41K. When this arrangement is adopted, the yellow head unit 41Y forms the yellow dots on the medium and thereafter the black ink is ejected, and therefore it is necessary to prevent bleeding between the yellow dots and the black dots. However, when the yellow dots is intensely pre-cured, as in the embodiment described above, the result is that the yellow dots shed the black ink, and there is a decline in the image quality of the color image. For this reason, in the comparative example, a light source 81Y for yellow for pre-curing the yellow dots is provided as a light source 81 for pre-curing. The light source 81Y for yellow irradiates with ultraviolet light at an irradiation energy for ordinary pre-curing, similarly with respect to the light source 81M for magenta and the light source 81C for cyan. However, when the yellow dots are irradiated with the comparatively weaker irradiation energy and pre-cured, the result is that the ultraviolet light is absorbed at the surface of the yellow dots, and the ultraviolet light does not reach the interior of the yellow dots. In such a case, only the surface of the yellow dots is cured, and the interior remains in a fluid state. When the yellow dots in this state are irradiated by the light source 91 for main curing with the ultraviolet light at a more intense irradiation energy and undergo the main curing, the yellow ink in the interior of the yellow dots is cured and shrinks, and this results in the occurrence of wrinkling at the surface (the surface having already been cured).

### Second Embodiment

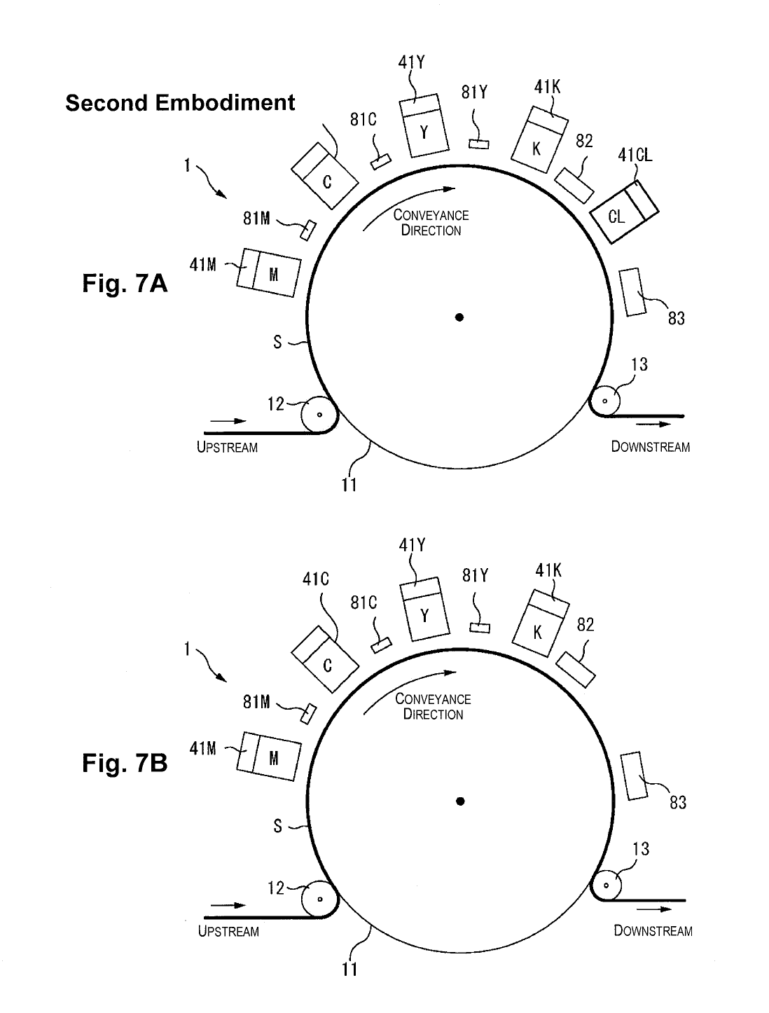

FIGS. 7A and 7B are schematic side views of a print apparatus 1 of the second embodiment. With comparison to the first embodiment, the yellow head unit is provided further upstream in the conveyance direction than the black head unit 41K, and the light source 81Y for yellow is provided as a light source 81 for pre-curing. Also, no light source 81K for black is provided as a light source 81 for pre-curing (instead, the light source 82 for intense pre-curing pre-cures the black ink).

In the second embodiment, too, where the irradiation energy of the light source 82 for intense pre-curing is P1 (=200 mJ/cm²), the irradiation energy of the light source 83 for main curing is P2 (=300 mJ/cm²), the irradiation energy needed for the main curing of the color inks is Pc (=500 mJ/cm²), and the irradiation energy needed for the main curing of the clear ink is Pcl (=280 mJ/cm²), then the relationships P1<Pc≦P1+P2 and Pcl<P2<Pc are fulfilled. Because the relationship has P1<Pc, the color dots (in particular, the black dots, which are the last to be formed) do not undergo the main curing at the stage where the dots are irradiated with the ultraviolet light from the light source 82 for intense pre-curing. For this reason, because the clear ink is applied before the color dots undergo the main curing, shedding of the clear ink by the color dots is minimized. In turn, because the relationship is Pc≦P1+P2, the color dots undergo the main curing upon being irradiated with the ultraviolet light from the light source 83 for main curing. Because the relationship is Pcl<P2, the clear dots undergo the main curing upon being irradiated with the ultraviolet light from the light source 83 for main curing. In turn, because the relationship is P2<Pc, the light source 83 for main curing can be constituted of a light source of lower irradiation energy, and the light source 83 for main curing can be reduced in size.

In the second embodiment, too, where the length of the light source 82 for intense pre-curing in the conveyance direction is L1, the length of the light source 83 for main curing in the conveyance direction is L2, the length of the light sources in the conveyance direction needed for the main curing of the color inks, and the length of the light sources in the conveyance direction needed for the main curing of the clear ink is Lcl, then the relationships L1<Lc≦L1+L2 and Lcl<L2<Lc are fulfilled.

The second embodiment results in the occurrence of wrinkling on the surface of the yellow dots, instead of the ability to minimize the occurrence of wrinkling of the black dots. When wrinkling occurs on the surface of dots of a color as bright as yellow, the shading caused by the wrinkling is easily visible, and there is a decline in the image quality. In the light of such reasons, the first embodiment is more preferable than the second embodiment.

### The UV Inks

### <Ink Compositions>

The following describes the additives (components) that either are included or can be included in the compositions for the UV inks of the foregoing embodiments (hereinafter also simply called “ink compositions”).

In the description that follows, “(meth)acrylate” signifies an acrylate and/or a methacrylate corresponding thereto, and a “(meth)acrylic” signifies an acrylic and/or a methacrylic corresponding thereto.

In the description that follows, the term “curable” refers to the property of being polymerized and cured by being irradiated with light, either in the presence or absence of a photopolymerization initiator. The term “ejection stability” refers to the property whereby stable ink droplets are always ejected from the nozzles, without clogging of the nozzles.

### (Polymerizable Compounds)

The polymerizable compounds included in the ink compositions in the present embodiment can be polymerized when irradiated with ultraviolet light by the action of a photopolymerization initiator described below, thus curing the printed ink.

### (Monomer A)

A monomer A, which in the present embodiment is requisite polymerizable compound, is a vinyl ether group-containing (meth)acrylic acid ester, and is represented by general formula (I) below.

CH²═CR¹—COOR²—O—CH═CH—R³ (I)

(in the formula, R¹ is a hydrogen atom or a methyl group; R² is a C2-20 divalent organic residue; and R³ is a hydrogen atom or a C1-11 monovalent organic residue)
By containing the monomer A, the ink compositions can be given a favorable ink curability.

Preferably, the C2-20 divalent organic residue represented by R² in general formula (I) above is: a C2-20 linear, branched, or cyclic alkylene group; a C2-20 alkylene group the structure of which includes an oxygen atom by an ether bond and/or an ester bond; or a C6-11 optionally substituted divalent aromatic group. Of these, it is particularly preferable to use: an ethylene group, an n-propylene group, an isopropylene group, a butylene group, or another such C2-6 alkylene group; or an oxyethylene group, an oxy n-propylene group, an oxyisopropylene group, an oxybutylene group, or another such C2-9 alkylene group alkylene group the structure of which includes an oxygen atom by an ether bond.

Preferably, the C1-11 monovalent organic residue represented by R³ in general formula (I) above is: a C1-10 linear, branched, or cyclic alkyl group; or a C6-11 optionally substituted aromatic group. Of these, it is particularly preferable to use: a methyl group, an ethyl group, or another such C1-2 alkyl group; or a phenyl group, a benzyl group, or another such C6-8 aromatic group.

In a case where the organic residue is an optionally substituted group, the substituent group thereof is divided into groups that include a carbon atom and groups that do not include a carbon atom. Firstly, in a case where the substituent group is a group that includes carbon atoms, the carbon atoms are counted by the number of carbons in the organic residue. Groups that include carbon atoms include but are not limited to, for example, a carboxyl group, an alkoxy group, and the like. Next, groups that do not include a carbon atom include but are not limited to, for example, a hydroxyl group or a halo group.

The monomer A includes, but is not limited, for example: 2-vinyloxyethyl(meth)acrylate, 3-vinyloxypropyl(meth)acrylate, 1-methyl-2-vinyloxyethyl (meth)acrylate, 2-vinyloxypropyl(meth)acrylate, 4-vinyloxybutyl(meth)acrylate, 1-methyl-3-vinyloxypropyl(meth)acrylate, 1-vinyloxymethylpropyl(meth)acrylate, 2-methyl-3-vinyloxypropyl(meth)acrylate, 1,1-dimethyl-2-vinyloxyethyl (meth)acrylate, 3-vinyloxybutyl(meth)acrylate, 1-methyl-2-vinyloxypropyl(meth)acrylate, 2-vinyloxybutyl(meth)acrylate, 4-vinyloxycyclohexyl(meth)acrylate, 6-vinyloxyhexyl(meth)acrylate, 4-vinyloxymethylcyclohexylmethyl(meth)acrylate, 3-vinyloxymethylcyclohexylmethyl (meth)acrylate, 2-vinyloxymethylcyclohexylmethyl(meth)acrylate, p-vinyloxymethylphenylmethyl(meth)acrylate, m-vinyloxymethylphenylmethyl (meth)acrylate, o-vinyloxymethylphenylmethyl(meth)acrylate, 2-(vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl(meth)acrylate, 2-(vinyloxyisopropoxy)propyl(meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl(meth)acrylate, 2-(vinyloxyethoxyisopropoxy)propyl (meth)acrylate, 2-(vinyloxyisopropoxyethoxy)propyl(meth)acrylate, 2-(vinyloxyisopropoxyisopropoxy)propyl(meth)acrylate, 2-(vinyloxyethoxyethoxy)isopropyl(meth)acrylate, 2-(vinyloxyethoxyisopropoxy)isopropyl (meth)acrylate, 2-(vinyloxyisopropoxyethoxy)isopropyl(meth)acrylate, 2-(vinyloxyisopropoxyisopropoxy)isopropyl(meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate.

Of these, 2-(vinyloxyethoxy)ethyl (meth)acrylate, i.e., 2-(vinyloxyethoxy)ethyl acrylate and/or 2-(vinyloxyethoxy)ethyl methacrylate has low viscosity, high flash point, and excellent curability, and is therefore more preferable; 2-(vinyloxyethoxy)ethyl acrylate is more preferable. Examples of 2-(vinyloxyethoxy)ethyl (meth)acrylate include 2-(2-vinyloxyethoxy)ethyl (meth)acrylate and 2-(1-vinyloxyethoxy)ethyl (meth)acrylate), and examples of 2-(vinyloxyethoxyl)ethyl acrylate 2-(2-vinyloxyethoxy)ethyl acrylate (hereinafter also called “VEEA”) and 2-(1-vinyloxyethoxy)ethyl acrylate.

The method for producing the monomer A includes but is not limited to: a method for esterifying (meth)acrylic acid with hydroxyl group-containing vinyl ether (production method B), a method for esterifying (meth)acrylic acid halide with hydroxyl group-containing vinyl ether (production method C), a method for esterifying (meth)acrylic anhydride with hydroxyl group-containing vinyl ether (production method D), a method for ester-exchanging (meth)acrylic acid ester with hydroxyl group-containing vinyl ether (production method E), a method for esterifying (meth)acrylic acid with halogen-containing vinyl ether (production method F), a method for esterifying (meth)acrylic acid alkali (earth) metal salt with halogen-containing vinyl ether (production method G), a method for vinyl-exchanging hydroxyl group-containing (meth)acrylic acid ester with vinyl carboxylate, and a method for ether-exchanging hydroxyl group-containing (meth)acrylic acid ester with alkyl vinyl ether (production method I).

(Polymerizable Compounds Other than the Monomer A)

Other than the vinyl ether group-containing (meth)acrylic acid esters cited above (the monomer A), it would also be possible to use a variety of monofunctional, bifunctional, trifunctional, or higher multifunctional monomers or oligomers known in the art (hereinafter also called “other polymerizable compounds”). Examples of monomers include (meth)acrylic acid, itaconic acid, crotonic acid, isocrotonic acid, maleic acid, and other such unsaturated carboxylic acids or the salts or esters thereof; urethane, amide, or the anhydrides thereof; or acrylonitrile, styrene, a variety of unsaturated polyesters, unsaturated polyethers, unsaturated polyamides, and unsaturated urethanes. Examples of oligomers include linear acrylic oligomers and other such oligomers formed from the monomers cited above, epoxy (meth)acrylate, oxetane (meth)acrylate), aliphatic urethane (meth)acrylates, aromatic urethane (meth)acrylate, and polyester (meth)acrylate.

An N-vinyl compound can also be included as another monofunctional monomer or multifunctional monomer. Examples of N-vinyl compounds include N-vinyl formamide, N-vinyl carbazole, N-vinyl acetamide, N-vinyl pyrrolidone, N-vinyl caprolactam, acryloyl morpholine, and the derivatives thereof.

Other the other polymerizable compounds, esters of (meth)acrylic acid, i.e., (meth)acrylates are preferable.

Of the (meth)acrylates, examples of monofunctional (meth)acrylates include isoamyl(meth)acrylate, stearyl(meth)acrylate, lauryl(meth)acrylate, octyl(meth)acrylate, decyl(meth)acrylate, isomyristyl(meth)acrylate, isostearyl(meth)acrylate, 2-ethylhexyl-diglycol (meth)acrylate, 2-hydroxybutyl(meth)acrylate, butoxyethyl(meth)acrylate, ethoxy diethylene glycol (meth)acrylate, methoxy diethylene glycol (meth)acrylate, methoxy polyethylene glycol (meth)acrylate, methoxy propylene glycol (meth)acrylate, phenoxyethyl(meth)acrylate, tetrahydrofurfuryl(meth)acrylate, isobornyl(meth)acrylate, 2-hydroxyethyl(meth)acrylate, 2-hydroxypropyl(meth)acrylate, 4-hydroxybutyl (meth)acrylate, 2-hydroxy-3-phenoxypropyl(meth)acrylate, lactone-modified flexible (meth)acrylate, t-butyl cyclohexyl(meth)acrylate, dicyclopentanyl(meth)acrylate and dicyclopentenyloxyethyl(meth)acrylate.

Of the (meth)acrylates cited above, examples of bifunctional (meth)acrylates include, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,4-butanediol di(meth)acrylate, dicyclopentanyl di(meth)acrylate, 1,6-hexanediol di(meth)acrylate, 1,9-nonanediol di(meth)acrylate, neopentyl glycol di(meth)acrylate, dimethylol tricyclodecane (meth)acrylate, an ethylene oxide (EO) adduct (meth)acrylate of bisphenol A, a propylene oxide (PO) adduct (meth)acrylate of bisphenol A, hydroxypivalic acid neopentyl glycol di(meth)acrylate, or polytetramethylene glycol di(meth)acrylate, and an acrylated amine compound obtained by reacting an amine compound with 1,6-hexanediol di(meth)acrylate. Commercially available examples of the acrylated amine compound obtained by reacting an amine compound with 1,6-hexandiol di(meth)acrylate include EBECRYL 7100 (a compound containing two amino groups and two acryloyl groups; Cytech) and the like.

Of the (meth)acrylates cited above, examples of trifunctional or higher multifunctional (meth)acrylate include trimethylolpropane tri (meth)acrylate, EO-modified trimethylolpropane tri (meth)acrylate, pentaerythritol tri(meth)acrylate, isocyanuric acid EO-modified tri (meth)acrylate, pentaerythritol tetra(meth)acrylate, dipentaerythritol hexa(meth)acrylate, ditrimethylolpropane tetra(meth)acrylate, glycerin propoxy tri(meth)acrylate, caprolactone-modified trimethylolpropane tri(meth)acrylate, pentaerythritol ethoxytetra(meth)acrylate, caprolactam-modified dipentaerythritol hexa(meth)acrylate.

Of these, preferably, the other polymerizable compounds include a monofunctional (meth)acrylate. In such a case, the ink composition is of lower viscosity, has excellent solubility of the photopolymerization initiator and other additives, and more readily yields ejection stability. Furthermore, preferably, a monofunctional (meth)acrylate and bifunctional (meth)acrylate are used in combination, because of the resulting increase in toughness, heat resistance, and chemical resistance of the ink coating.

Preferably, the monofunctional (meth)acrylate has one or more backbones selected from the group consisting of an aromatic backbone, aromatic backbone, a saturated alicyclic backbone, and an unsaturated alicyclic backbone. By being a monofunctional (meth)acrylate having a backbone cited above, the other polymerizable compounds make it possible to lower the viscosity of the ink composition.

Examples of a monofunctional (meth)acrylate having an aromatic backbone include phenoxyethyl(meth)acrylate and 2-hydroxy-3-phenoxy propyl(meth)acrylate. Examples of a monofunctional (meth)acrylate having a saturated alicyclic backbone include isobornyl(meth)acrylate, t-butyl cyclohexyl(meth)acrylate, and dicyclopentanyl (meth)acrylate). Examples of a monofunctional (meth)acrylate having an unsaturated alicyclic backbone include dicyclopentenyloxy ethyl(meth)acrylate.

Of these, phenoxy ethyl(meth)acrylate is preferable because the viscosity and malodorous smell can be reduced.

The polymerizable compounds other than the monomer A are preferably contained in the amount of 10-35 mass % with respect to the total mass of the ink composition (100 mass %). When the amount contained is within the range cited above, the additive solubility is excellent and the toughness, heat resistance, and chemical resistance of the ink coating are excellent.

Either one species alone of the polymerizable compounds above can be used, or two or more species can be used in combination.

### (The Photopolymerization Initiator)

The photopolymerization initiator included in the ink composition of the present embodiment is used in order to form print by curing the ink present on the surface of the medium receiving the recording, by a photopolymerization caused by the irradiation with the ultraviolet light. Of the forms of radiation, the use of ultraviolet (UV) makes it possible have excellent safety and minimize the costs of the light source lamps.

The photopolymerization initiator, encompasses an acylphosphine-based photopolymerization initiator and a thioxanthone-based photopolymerization initiator. This makes it possible have excellent curability of the ink, and moreover makes it possible to prevent coloration of the cured film early after printing. In addition thereto, the acylphosphine-based photopolymerization initiator and the thioxanthone-based photopolymerization initiator, as stated above, are contained in total in the amount of 9-14 mass %, preferably 10-13 mass %, more preferably 11-13 mass %, with respect to the total mass of the ink composition (100 mass %). When the total amount thereof contained in the ink is within the range cited above, the ink has very excellent curability and ejection stability. In particular, when the amount contained is 9 mass % or more, the viscosity is comparatively higher and it is possible to prevent an increase in misting, which would cause fouling of the image, for which reason the ink has excellent ejection stability.

### (The Acylphosphine-Based Photopolymerization Initiator)

The photopolymerization initiator in the present embodiment includes an acylphosphine-based photopolymerization initiator, i.e., an acylphosphine oxide-based photopolymerization initiator (hereinafter also simply called an “acylphosphine oxide”). This causes the ink to have excellent curability in particular, and makes it possible to prevent coloration of the coated film early after printing and to prevent coloration after formation of the cured film (the initial degree of coloration of the cured film is smaller).

Examples of the acylphosphine oxide include but are not particularly limited to 2,4,6-trimethylbenzoyl diphenyl phosphine oxide, 2,4,6-triethylbenzoyl diphenyl phosphine oxide, 2,4,6-triphenylbenzoyl diphenylphosphine oxide, bis(2,4,6-trimethyl benzoyl)-phenyl phosphine oxide, and bis(2,6-dimethoxyphenyl)-2,4,4-trimethylpentyl phosphine oxide.

Commercially available examples of acylphosphine oxide-based photopolymerization initiators include DAROCUR TPO (2,4,6-trimethylbenzoyl diphenylphosphine oxide), IRGACURE 819 (bis(2,4,6-trimethylbenzoyl)-phenyl phosphine oxide), and CGI 403 (bis(2,6-dimethoxybenzoyl)-2,4,4-trimethylpentyl phosphine oxide).

Preferably, the acylphosphine oxide includes monoacylphosphine oxide. This causes the photopolymerization initiator to fully dissolve and causes the curing to progress fully, and also causes the ink to have excellent curability.

Examples of the monoacylphosphine oxide include but are not particularly limited to 2,4,6-trimethylbenzoyl diphenylphosphine oxide, 2,4,6-triethylbenzoyl diphenylphosphine oxide, and 2,4,6-triphenylbenzoyl diphenylphosphine oxide. Of this, 2,4,6-trimethylbenzoyl diphenylphosphine oxide is preferable.

Commercially available examples of the monoacylphosphine oxide include DAROCUR TPO (2,4,6-trimethylbenzoyl diphenylphosphine oxide).

The photopolymerization initiator in the present embodiment is preferably either monoacylphosphine oxide or a mixture of monoacylphosphine oxide and bisacylphosphine oxide, because of the resulting excellent solubility into the polymerizable compounds, excellent interior curability of the ink coating, and lower degree of initial coloration. Examples of a bisacylphosphine oxide include but are not particularly limited to bis(2,4,6-trimethylbenzoyl)phenylphisphine oxide and bis(2,4,6-dimethoxybenzoyl)-2,4,4-trimethylpentyl phosphine oxide. Of these, bis(2,4,6-trimethylbenzoyl)phenylphosphine oxide is preferable.

The acylphosphine oxide is contained preferably in an amount in the range of 8-11 mass %, more preferably in an amount in the range of 10-11 mass %, with respect to the total mass of the ink composition (100 mass %). When the amount contained is within the range cited above, the ink has excellent curability and the initial degree of coloration of the cured film is low.

### (The Thioxanthone-Based Photopolymerization Initiator)

The photopolymerization initiator in the present embodiment includes a thioxanthone-based photopolymerization initiator (hereinafter also simply called a “thioxanthone”). This causes the ink to have excellent curability and in particular lowers the initial degree of coloration of the cured film.

Of the thioxanthones, 2,4-diethyl thioxanthone has excellent efficacy in sensitizing the acylphosphine oxide, solubility in the polymerizable compounds, and stability, and is therefore preferable.

Commercially available examples of thioxanthones include KAYACURE DETX-S (2,4-diethyl thioxanthone) (product name; Nippon Kayaku), ITX (BASF), and Quantacure CTX (Aceto Chemical).

The thioxanthone is contained preferably in an amount in the range of 1-3 mass %, more preferably in the range of 2-3 mass %, with respect to the total mass of the ink composition (100 mass %). When the amount contained is within the range cited above, the ink has excellent curability and the initial degree of coloration of the cured film is lower.

### (The Coloring Material)

The ink composition of the present embodiment can also include a coloring material. A pigment and/or dye can be used as the coloring material.

### (Pigment)

In the present embodiment, using a pigment as the coloring material makes it possible to enhance the light fastness of the ink composition. Either an inorganic pigment or an organic pigment can be used as the pigment.

Furnace black, lamp black, acetylene black, channel black, or another such carbon black (C.I. Pigment Black 7); iron oxide; or titanium oxide can be used as an inorganic pigment.

Examples of organic pigments include an insoluble azo pigment, a condensed azo pigment, an azo lake, a chelate azo pigment, or another such azo pigment; a phthalocyanine pigments, perylene or perinone pigments, an anthraquinone pigment, a quinacridone pigment, a dioxane pigment, a thioindigo pigment, an isoindolinone pigment, a quinophthalone pigment, or another such polycyclic pigment; a dye chelate (for example, a basic dye type chelate, an acidic dye type chelate, or the like); a dye lake (a basic dye type lake or an acidic dye type lake); or a nitro pigment, a nitroso pigment, aniline black, or a daylight fluorescent pigment.

More specifically, examples of a carbon black used as a black ink include No. 2300, No. 900, MCF88, No. 33, No. 40, No. 45, No. 52, MA7, MA8, MA 100, No. 2200B, or the like (the foregoing being product names by Mitsubishi Chemical Corporation); Raven 5750, Raven 5250, Raven 5000, Raven 3500, Raven 1255, Raven 700, or the like (the foregoing being product names by Carbon Columbia); Regal 400R, Regal 330R, Regal 660R, Mogul L, Monarch 700, Monarch 800, Monarch 880, Monarch 900, Monarch 1000, Monarch 1100, Monarch 1300, Monarch 1400, or the like (product names by CABOT JAPAN); and Color Black FW1, Color Black FW2, Color Black FW2V, Color Black FW18, Color Black FW200, Color Black 5150, Color Black 5160, Color Black S170, Printex 35, Printex U, Printex V, Printex 140U, Special Black 6, Special Black 5, Special Black 4A, Special Black 4, and the like (the foregoing being product names by Degussa).

Examples of pigments used in white ink include C. I. Pigment and White 6, 18, and 21. A metal atom-containing compound that can be used as a white pigment can also be used; examples include metal oxides that have been used as white-colored pigments, barium sulfate, and calcium carbonate. Examples of the metal oxides include but are not limited to titanium dioxide, zinc oxide, silica, alumina, and magnesium oxide.

Examples of pigments that can be used in the yellow ink include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of pigments that can be used in the magenta ink include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, or C.I. Pigment Violet 19, 23, 32, 33, 36, 38, 43, and 50.

Examples of pigments that can be used in the cyan ink include C.I. Pigment Blue 1, 2, 3, 15, 15:1, 15:2, 15:3, 15:34, 15:4, 16, 18, 22, 25, 60, 65, and 66, or C.I. Vat Blue 4 and 60.

Examples of pigments other than magenta, cyan, or yellow include C.I. Pigment Green 7 and 10, or C.I. Pigment Brown 3, 5, 25, and 26, or C.I. Pigment Orange 1, 2, 5, 7, 13, 14, 15, 16, 24, 34, 36, 38, 40, 43, and 63.

Either one type alone of the pigments above can be used, or two or more types can be used in combination.

In a case where a pigment cited above is used, the mean grain size thereof is preferably not greater than 2 μm, more preferably 30-300 nm. When the mean grain size is within the range cited above, the ink composition has more excellent reliability, such as in the ejection stability and the dispersion stability, and also an image of excellent image quality can be formed. Herein, the mean grain size in the present specification is measured by a dynamic light scattering technique.

### (Dye)

In the present embodiment, a dye can be used as a coloring material. Examples of dyes that can be used include but are not particularly limited to acid dyes, direct dyes, reactive dyes, and basic dyes. Examples of the dyes include C.I. Acid Yellow 17, 23, 42, 44, 79, and 142; C.I. Acid Red 52, 80, 82, 249, 254, and 289; C.I. Acid Blue 9, 45, and 249; C.I. Acid Black 1, 2, 24, and 94; C.I. Food Black 1 and 2; C.I. Direct Yellow 1, 12, 24, 33, 50, 55, 58, 86, 132, 142, 144, and 173; C.I. Direct Red 1, 4, 9, 80, 81, 225, and 227; C.I. Direct Blue 1, 2, 15, 71, 86, 87, 98, 165, 199, and 202; C.I. Direct Black 19, 38, 51, 71, 154, 168, 171, and 195; C.I. Reactive Red 14, 32, 55, 79, and 249; or C.I. Reactive Black 3, 4, and 35.

Either one type alone of the dyes cited above can be used, or two or more types can be used in combination.

The coloring material is contained preferably in an amount in the range of 1.5-6 mass % for CMYK and preferably in an amount in a range of 15-30 mass % for W, with respect to the total mass of the ink composition (100 mass %), because of the resulting favorable color production performance and ability to inhibit curing of the ink coating caused by light absorption by the coloring material itself.

### (Dispersant)

In a case where the ink composition of the present embodiment includes a pigment, a dispersant can also be included in order for the pigment dispersibility to be more favorable. Examples of dispersants include but are not particularly limited to dispersants that have been customarily used to prepare a pigment dispersant such as a polymeric dispersant. Specific examples include a dispersant mainly composed of at least one species from among polyoxyalkylene polyalkylene polyamine, vinyl-based polymers and oligomers, acrylic-based polymers and oligomers, polyesters, polyamides, polyimides, polyurethanes, amine-based polymers, silicon-containing polymers, sulfur-containing polymers, and epoxy resins. Commercially available examples of polymeric dispersants include the AJISPER series (product name by Ajinomoto Fine-Techno), the SOLSPERSE Series (such as Solsperse 36000; product name that can be procured from Lubrizol), the DISPERBYK series (product name by BYK Chemie), and the DISPARLON SERIES (product name by Kusumoto Chemicals).

### (Leveling Agent)

The ink composition of the present embodiment can also include a leveling agent (a surfactant), because the resulting wettability on the print substrate is favorable. Examples that can be used as the leveling agent include but are not particularly limited to polyester-modified silicone or polyether-modified silicone as silicone-based surfactants; it is particularly preferable to use polyether-modified polydimethylsiloxane or polyester-modified polydimethylsiloxane. Specific examples that can be used include BYK-347, BYK-348, and BYK-UV 3500, 3510, 3530, or 3570 (product names by BYK Japan).

### (Polymerization Inhibitor)

The ink composition of the present embodiment can also include a polymerization inhibitor, in order for the storage stability of the ink composition to be favorable. Examples of polymerization inhibitors include but are not particularly limited to IRGASTAB UV10 and UV22 (product names by BASF) or hydroquinone monomethyl ether (MEHQ, product name by Kanto Chemical).

### (Other Additives)

The ink composition of the present embodiment can include additives (components) other than the additives mentioned above. Examples of such components could include but are not particularly limited to a polymerization accelerator, a penetration enhancer, a wetting agent (humectant), or other additives known in the art. Examples of other additives include a fixing agent, an antifungal agent, a preservative, an antioxidant, an ultraviolet light absorbing agent, a chelating agent, a pH adjuster, or a thickener, known in the art.

### (Physical Properties of the Ink Composition)

The ink composition of the present embodiment preferably has a viscosity at 20° C. not greater than 15 mPa·s, more preferably 9-14 mPa·s. When the viscosity is within the range cited above, there is excellent solubility of the photopolymerization initiator and other additives, and ejection stability is more readily obtained. The viscosity in the present specification is a value measured by using the MCR300 rheometer (DKSH Japan). The ink composition of the present embodiment also preferably can be cured by being irradiated with ultraviolet light that has a light-emitting peak wavelength of 365-405 nm.

### Specific Example

The components used in UV inks were as follows.

### (Pigments)

FASTOGEN BLUE (color index name: Pigment Blue 15:4; product name made by DIC; abbreviated as “cyan” in table 1)
SYMULER FAST YELLOW (color index name: C.I. Pigment Yellow 180; product name made by DIC; abbreviated as “yellow” in table 1)
MICROLITH-WA Black C-WA (color index name: C.I. Pigment Black 7; product name made by BASF; abbreviated as “black” in table 1)
CROMOPHTAL PinkPT(SA) GLVO (color index name: C.I. Pigment Red 122; product name made by BASF; abbreviated as “magenta” in table 1)

### (Dispersant)

SOLSPERSE 36000 (amine-based; product name by Lubrizol; abbreviated as “amine-based dispersant A” in table 1)

### (Polymerizable Compounds)

VEEA (2-(2-vinyloxyethoxy) ethyl acrylate; product name made by Nippon Shokubai; abbreviated as “VEEA” in table 1)
Biscoat #192 (phenoxyethyl acrylate; product name made by OSAKA ORGANIC CHEMICAL INDUSTRY; abbreviated as PEA in table 1)
4-HBA (4-hydroxybutyl acrylate; product name made by Osaka Organic Chemical Industry; abbreviated as “4-HBA” in table 1)
KAYARAD R-684 (tricyclodecane dimethylol diacrylate; product name made by Nippon Kayaku; abbreviated as “R-684” in table 1)
A-DPH (dipentaerythritol hexaacrylate; product name made by SHIN-NAKAMURA CHEMICAL; abbreviated as A-DPH in table 1)

### (Polymerization Inhibitor)

MEHQ (product name made by Kanto Chemical; abbreviated as “MEHQ” in table 1)

### (Leveling Agent)

Silicone-based surface conditioner BYK-UV3500 (product name made by BYK; abbreviated as UV 3500 in table 1)

### (Photopolymerization Initiators)

IRGACURE 819 (product name made by BASF; abbreviated as “819” in table 1)
DAROCUR TPO (product name made by BASF; abbreviated as “TPO” in table 1)
KAYACURE DETX-S (product name made by Nippon Kayaku; abbreviated as “DETX-S” in table 1)

Firstly, pigment dispersion solutions were prepared by mixing the pigments and dispersants listed in table 1 below so as to reach the compositions listed in table 1 (units: mass %). Next, the other components listed in table 1 below were added to the pigment dispersion solutions thus prepared, so as to reach the compositions listed in table 1 (units: mass %), and the solutions were stirred with a high-speed water-cooled stirrer to thereby obtain UV inks for each of the colors (cyan C, magenta M, yellow Y, black K, and clear C). The blanks in table 1 signify that a component was not added.

TABLE 1

| Item | Material name | C | M | Y | K | CL |
|---|---|---|---|---|---|---|
| Pigment | Cyan | 2.2 | | | | |
| dispersant | Magenta | | 4.0 | | | |
| | Yellow | | | 3.1 | | |
| | Black | | | | 2.0 | |
| | Amine-based | 0.7 | 1.5 | 1.5 | 0.7 | |
| | dispersant A | | | | | |
| | PEA | 12.1 | 14.5 | 16.0 | 10.6 | |
| Polymer- | VEEA | 30.0 | 32.0 | 33.0 | 40.0 | 40.2 |
| izable | PEA | 23.7 | | | 3.9 | 13.0 |
| compound | 4-HBA | 17.9 | 35.6 | 28.4 | 23.2 | 26.5 |
| | R-684 | | | | | 8.0 |
| | A-DPH | | | 1.6 | 4.2 | |
| Other | MEHQ | 0.2 | 0.2 | 0.2 | 0.2 | 0.1 |
| additives | UV3500 | 0.2 | 0.2 | 0.2 | 0.2 | 0.2 |
| Polymer- | 819 | 7.0 | 7.0 | 7.0 | 7.0 | 5.0 |
| ization | TPO | 5.0 | 4.0 | 6.0 | 3.0 | 7.0 |
| initiator | DETX-S | 1.0 | 1.0 | 3.0 | 5.0 | |
| Total | | 100.0 | 100.0 | 100.0 | 100.0 | 100.0 |

### (Other)

The embodiments above are intended to facilitate understanding of the invention, and are not to be construed as limiting the invention. It shall be readily understood that the invention can also be modified or improved without departing from the spirit thereof, and that the invention encompasses equivalents thereof.

What is claimed is:

1. A print apparatus, comprising:
a conveyance unit for conveying a medium in a conveyance direction;
a magenta head for ejecting a magenta ink, which is a color ink that includes a photopolymerization initiator;
a cyan head for ejecting a cyan ink, which is a color ink that includes a photopolymerization initiator;
a black head for ejecting a black ink, which is a color ink that includes a photopolymerization initiator;
a yellow head for ejecting a yellow ink, which is a color ink that includes a photopolymerization initiator;
a first light source;
a clear head for ejecting a clear ink that includes a photopolymerization initiator; and
a second light source;
the print apparatus being characterized in that:
the first light source is provided further downstream in the conveyance direction than the magenta head, the cyan head, the black head, and the yellow head;
the clear head is provided further downstream in the conveyance direction than the first light source;
the second light source is provided further downstream in the conveyance direction than the clear head; and
where Pc is an irradiation energy needed for main curing of the color inks, Pcl is an irradiation energy needed for main curing of the clear ink, P1 is an irradiation energy of the first light source, and P2 is an irradiation energy of the second light source,
the relationships
P1<Pc≦P1+P2 and
Pcl<P2<Pc
are fulfilled.

2. The print apparatus as set forth in claim 1, wherein
the yellow head is provided further downstream in the conveyance direction than the magenta head, the cyan head, and the black head, and
the print apparatus is provided with:
a light source for magenta, provided on the downstream side of the magenta head in the conveyance direction;
a light source for cyan, provided on the downstream side of the cyan head in the conveyance direction; and
a light source for black, provided on the downstream side of the black head in the conveyance direction;
the first light source irradiating light at a more intense irradiation energy than irradiation energies of the light source for magenta, the light source for cyan, and the light source for black.

3. The print apparatus as set forth in claim 1, wherein
the conveyance unit has a drum for conveying the medium by rotating, and
the magenta head, the cyan head, the black head, the yellow head, the first light source, the clear head, and the second light source are provided along the surface of the drum.

4. The print apparatus as set forth claim 1, wherein
the first light source and the second light source are constituted of an LED.

5. A print apparatus, comprising:
a conveyance unit for conveying a medium in a conveyance direction;
a magenta head for ejecting a magenta ink, which is a color ink that includes a photopolymerization initiator;
a cyan head for ejecting a cyan ink, which is a color ink that includes a photopolymerization initiator;
a black head for ejecting a black ink, which is a color ink that includes a photopolymerization initiator;
a yellow head for ejecting a yellow ink, which is a color ink that includes a photopolymerization initiator;
a first light source;
a clear head for ejecting a clear ink that includes a photopolymerization initiator; and
a second light source;
the print apparatus being characterized in that:
the first light source is provided further downstream in the conveyance direction than the magenta head, the cyan head, the black head, and the yellow head;
the clear head is provided further downstream in the conveyance direction than the first light source;
the second light source is provided further downstream in the conveyance direction than the clear head; and
where L1 is the length of the first light source in the conveyance direction and L2 is the length of the second light source in the conveyance direction, and
where Lc is the length in the conveyance direction of a light source needed for main curing of the color links and Lcl is the length in the conveyance direction of a light source needed for main curing of the clear ink in a case where the medium is conveyed at a predetermined conveyance speed and light is irradiated from the first light source and from the second light source at a predetermined irradiation intensity, the relationships
L1<Lc≦L1+L2 and
Lcl<L2<Lc
are fulfilled.

6. A print method, comprising:
a conveyance unit for conveying a medium in a conveyance direction;
a magenta head for ejecting a magenta ink, which is a color ink that includes a photopolymerization initiator;
a cyan head for ejecting a cyan ink, which is a color ink that includes a photopolymerization initiator;
a black head for ejecting a black ink, which is a color ink that includes a photopolymerization initiator;
a yellow head for ejecting a yellow ink, which is a color ink that includes a photopolymerization initiator;
a first light source;
a clear head for ejecting a clear ink that includes a photopolymerization initiator; and
a second light source;
the print method being characterized in that:
the first light source is provided further downstream in the conveyance direction than the magenta head, the cyan head, the black head, and the yellow head;
the clear head is provided further downstream in the conveyance direction than the first light source;
the second light source is provided further downstream in the conveyance direction than the clear head; and
where Pc is an irradiation energy needed for main curing of the color inks, Pcl is an irradiation energy needed for main curing of the clear ink, P1 is an irradiation energy of the first light source, and P2 is an irradiation energy of the second light source, the relationships
P1<Pc≦P1+P2 and
Pcl<P2<Pc
are fulfilled.

7. A print method, comprising:
a conveyance unit for conveying a medium in a conveyance direction;
a magenta head for ejecting a magenta ink, which is a color ink that includes a photopolymerization initiator;
a cyan head for ejecting a cyan ink, which is a color ink that includes a photopolymerization initiator;
a black head for ejecting a black ink, which is a color ink that includes a photopolymerization initiator;
a yellow head for ejecting a yellow ink, which is a color ink that includes a photopolymerization initiator;
a first light source;
a clear head for ejecting a clear ink that includes a photopolymerization initiator; and
a second light source;
the print method being characterized in that: the first light source is provided further downstream in the conveyance direction than the magenta head, the cyan head, the black head, and the yellow head;
the clear head is provided further downstream in the conveyance direction than the first light source;
the second light source is provided further downstream in the conveyance direction than the clear head; and
where L1 is the length of the first light source in the conveyance direction and L2 is the length of the second light source in the conveyance direction, and
where Lc is the length in the conveyance direction of a light source needed for main curing of the color links and Lcl is the length in the conveyance direction of a light source needed for main curing of the clear ink in a case where the medium is conveyed at a predetermined conveyance speed and light is irradiated from the first light source and from the second light source at a predetermined irradiation intensity, the relationships
L1<Lc≦L1+L2 and
Lcl<L2<Lc
are fulfilled.
